(19) United States
(12) Patent Application Publication
(10) Pub. No.: US 2007/0222704 A1
(43) Pub. Date: Sep. 27, 2007

(54) Visual Display

(76) Inventor: Da Wei Huang, New South Wales (AU)

Correspondence Address: KEVIN J. MCNEELY, ESQ., 5335 WISCONSON AVENUE, NW, SUITE 440, WASHINGTON, DC, 20015, US

(21) Appl. No.: 11/569,359

(22) PCT Filed: Aug. 8, 2005
(86) PCT No.: PCT/AU05/01171

§ 371 Date: Nov. 18, 2006

Related U.S. Application Data
(60) Provisional application No. 60/602,773, filed on Aug. 19, 2004.

(51) Int. Cl. G09G 3/00

(52) U.S. Cl. 345/32

(57) ABSTRACT

A visual display is formed by picture elements, which are optically coupled to optical pathways through which light is supplied from light sources. Light sources, controlled by control hardware, transmit light to the optical pathways by scanning light from the light sources to different optical pathways. The light sources and the optical pathways are mutually oriented so that light from the light sources can be canned to different optical pathways to form the displayed image. Light sources can be mounted to a rotating mounting that rotates past static pathways that transmit coupled light to the waveguide screen.

### FIELD OF THE INVENTION

The present invention relates to visual displays, and relates particularly to optical flat panel displays, by which 2D vision or 3D vision can be seen.

### BACKGROUND

There are various categories of electronic display technology. These include cathode ray tube displays, liquid crystal displays, plasma display panels, and rear projection displays. The advantages and disadvantages of each of these display technologies is understood, and each of these technologies find their own niche applications. Cathode ray tube displays and liquid crystal displays are currently dominate the display market, though other technologies are emerging as viable alternative for television and computer display applications.

As an example, cathode ray tube (CRT) televisions remain dominant. CRT televisions are, however, proportionately large and heavy for the size of the screen, and do not offer a high definition display at an affordable price. Liquid crystal displays (LCDs) are emerging as a significant market segment. LCDs are more widely used as computer monitors as well as strong challenge into the lucrative flat panel televisions application. The issue of wasting large amount of back light sources due to LCD working environment can not be avoided nevertheless. Plasma display panels (PDPs) have the advantage of slim volume, and well as colour intensity and saturation. PDP production, however, currently has a low yield rate and are accordingly expensive. Rear projection displays are an alternative solution for much bigger area display as long as the application has no strict limit of longitudinal space. Most projection style technologies are not for outdoor application.

It is also regarded as a challenge task to use current electronic display technologies to display 3D video images without substantially enhancement of optical components.

A need clearly exists for a display technology that provides further options for selected display applications.

### SUMMARY

A display technology is described herein in which optical pathways are used to supply light to picture elements (pixels) of a “waveguide” display. Lines of light information are vertically or horizontally scanned onto the display screen via optical pathways using light coupled from light sources.

A visual display is formed by picture elements, or pixels. The picture elements are optically coupled to optical pathways through which light is supplied to the picture elements. Light sources, controlled by control hardware, transmit light to the optical pathways by scanning light from the light sources to different optical pathways. The light sources and the optical pathways are mutually oriented so that light from the light sources can be scanned to different optical pathways to form the displayed image. Control hardware is used to control switching of the light sources to generate a still or video image.

Different configurations are possible to scan light from the light sources to the optical pathways. The light sources may be mounted on a rotatable substrate, which rotates relative to the optical pathways to scan light to the optical pathways. The light sources are directly coupled to the waveguide channels.

Alternatively, a roller revolves at steady speed to couple (or scan) light rays into the waveguide channels. The light sources can be fixed, and used in conjunction with a transparent roller having a reflective surface along its diameter, which is used to reflect light to the waveguide channels as the reflective surface rotates.

Direct optical coupling involves direct light transport from the light sources to the optical pathways. Indirect optical coupling involves reflection via a mirror between the light sources to the optical pathways. A rotational relation exists in both cases to effectively scan light from the light sources to the optical pathways, as described herein.

Particular advantages of the designs described herein are that there is no electronic circuitry is required on the display screen surface, and that there is the possibility of repairing electronic parts and faulty light sources. Further, industrial production can be simple and requires less capital investment. There is no technology barrier to produce panels of various sizes, formats, with only a few small modules and components. Display panels capable to show 3D video images with or without eye gears can also be made by this technology.

### DESCRIPTION OF DRAWINGS

FIG. 1 is a schematic representation of components of the waveguide a display described herein.

FIG. 2 is a schematic representation of a waveguide screen and optical pathways that form part of the waveguide display described herein.

FIG. 3 is a timing diagram for a simplified image display using the waveguide display described herein.

FIG. 4 is a timing diagram of different digital pulse trains used for varying the intensity of light sources used in the waveguide display described herein.

FIG. 5 is a schematic representation of electrical circuitry for implementing control hardware for the waveguide display described herein.

FIG. 6 is a schematic representation of part of a rotating roller for use in conjunction with the waveguide screen system represented in FIG. 2.

FIG. 7 is a schematic representation of a 3D display apparatus whose waveguide pathways have been modified as alternative design option from the system represented in FIG. 2

### DETAILED DESCRIPTION

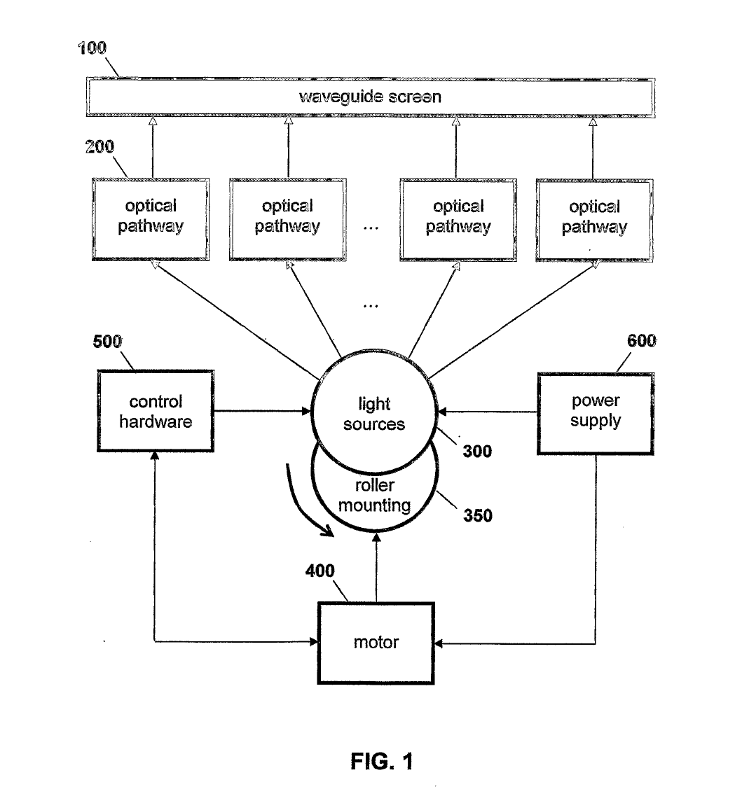

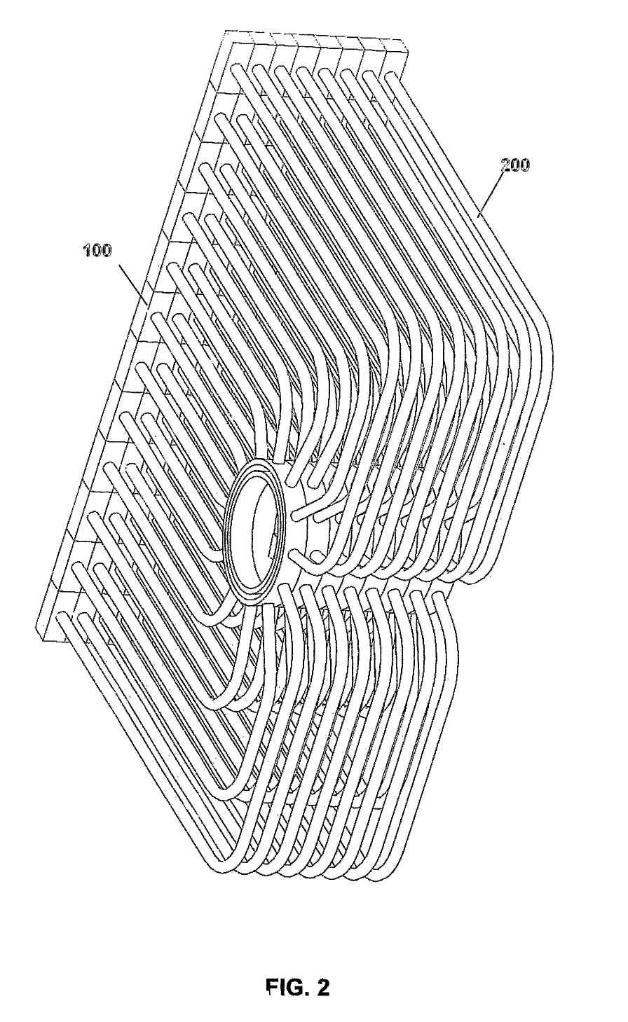

FIG. 1 schematically represents components of the waveguide display 1000 described herein. A waveguide screen 100, which displays an image provided via optical pathways 200. Light sources 300 are controlled by control hardware 500 to supply light to the optical pathways 200. A roller mounting 350 is a transparent cylinder intersected along its diameter by double-sided reflective surface, for reflecting light from the light sources 30 to the optical pathways 200. A power supply 500 powers the light sources 300 and motor 400, and may also be used to power the control hardware 500. Other power supply arrangements can be adopted depending upon design details, as required, and as described in further detail below.

Waveguide Screen

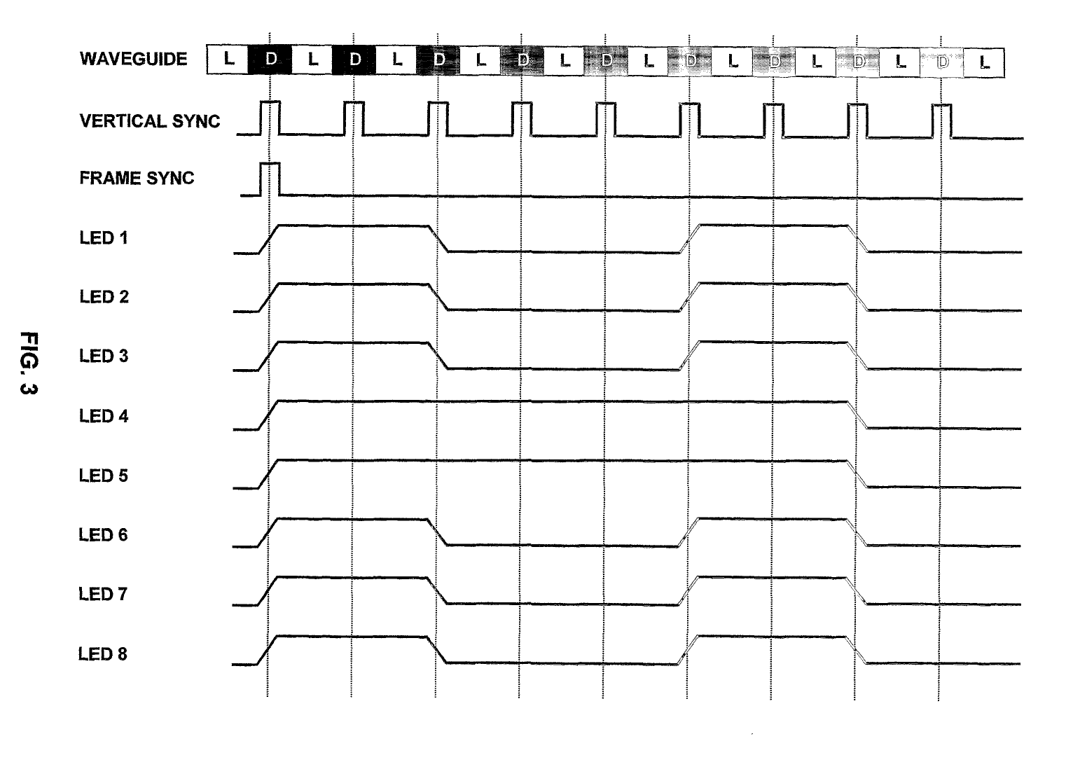

FIG. 2 schematically represents the waveguide screen 100, which can be substantially flat and rectangular in shape, as is the case with existing displays. Curved shapes, even 360-degree “wrap-around” displays can also be provided to suit specialized applications. Regardless what screen shapes are adopted, the principle of operations remains unchanged.

The waveguide screen 100 provides a relatively transparent or translucent medium for transmitting light delivered by the optical pathways 200. Individual pixels of the waveguide screen 100 may be effectively 1 mm by 1 mm in dimension, but may be greater or smaller dimensions. A rectangular matrix of pixels is generally preferred for convenience, though other arrangements, such as matrices of hexagonally-arranged pixels can also be adopted if appropriate. A rectangular matrix may of course be square or non-square in dimension.

Further, the precise boundaries between pixels need not be structurally delineated. Light from optical pathways 200 can diffuse though a localized area of the waveguide screen 100 to appropriately form part of the displayed image.

Other designs may call for a waveguide screen 100 that is fabricated from a matrix of optical elements that have minimal optical interference at the interface between pixels. Such designs are not described in any further detail.

Optical Pathways

Optical pathways 200 can be formed from optical fibers, either a single optical fiber or a cluster of optical fibers forming a single pathway associated with a single screen pixel. Typically, a single optical fiber can be used, with a cross-sectional diameter of 750 μm, for example. Thicker or thinner fibers 200 may also be used. One suitable optical fiber 200 is the Mitsubishi ES plastic optical fiber (POF), which is produced in diameters of 0.25 mm, 0.50 mm, 0.75 mm, and 1.00 mm, amongst other sizes.

As described above, the optical fibers 200 provide light from light sources 300 to the display plane of a screen 100. The fibers 200 are most conveniently directly coupled to the screen 100. One way of achieving such a direct coupling is using an optical adhesive. Small apertures can be formed in the rear (that, non-display) surface of the screen 100 to accept ends of the optical fibers 200. Each aperture represents a respective pixel of the screen 100. Such an aperture provides a channel into which the optical fiber 200 can be inserted, both to assist a firm fixture of the optical fiber 200 to the rear of the screen 100, and also to improve optical coupling between the optical fibers 200 and the screen 100. This is one way of achieving a precise pixel pitch for a large quantity of optic fiber assembly, though various manufacturing techniques can be used.

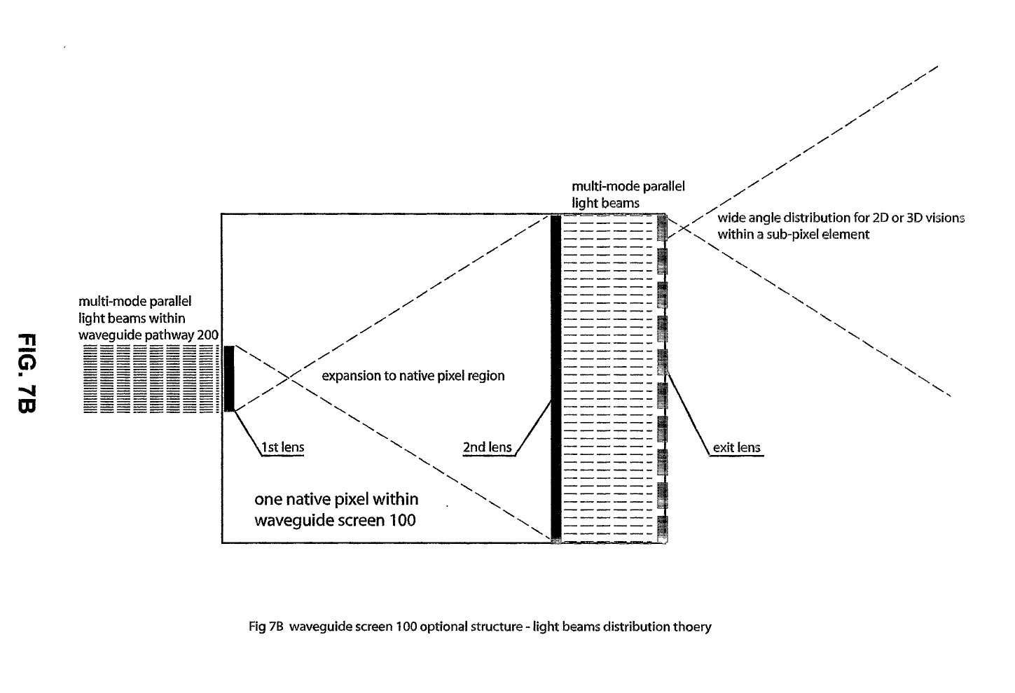

Alternative choice that requires no optic fiber 200 option is shown in FIG. 7. In this design option, optic lens 210 located at the edge of the light scan distributional circumference in each level of distribution circle will form divisional regions where optic lens 210 described herein will reconstruct light rays from the normal passages of appearing geometrically like a sector into coherent light beams parallel with the lens 210 optic axis. Each waveguide passage 200 in this design needs maximum two planar reflective surfaces 220 and 230, on which reconstructed parallel light beams will be redirected within waveguide pathways 200 before exiting from the screen perpendicularly. In theory light beams profile is far less likely to be distorted during its propagation within such an optic waveguide passages. Consequently optic fiber 200 in the design as FIG. 7 showing will not be necessary. Optical pathways is more preferably being hollow, solid or liquid medium in which coherent light beams can travel through to the designated display elements with minimum optical lost.

Light Sources

Light emitting diodes (LEDs) with low emitting angle are a suitable choice of light sources 300 if light sources are mounted at the scan distributional circumference where closes to waveguide channels. As LEDs are relatively small in size, have a fast response time and strong light intensity. Further, LEDs produce natural visual spectrum colours without the use of filters, and are reliable during continual use. LEDs are also available in primary colour (RGB, red-green-blue) components that form the basis of many existing panchromatic display technologies. These are all desirable attributes for the light sources 300. Any suitable type of LED can be used, subject to having sufficient response time for switching for a particular application.

Other possible light sources include laser lights, which can also provide coherent primary colour components, and may be suitable for use in particular applications.

Rotating Light Sources

A roller mounting 350 that houses and rotates the light sources 300 can be used to supply light to the optical pathways 200. The LEDs can be mounted on the roller mounting on a number of flanges, conveniently in a vertical column. Many variations are of course possible. The positioning of the light sources 300 accords with the switching sequence of the light sources 300 as the light sources 300 scan past apertures to the optical pathways 200.

Control hardware 500 may be housed within the roller mounting 500, as described below, or elsewhere. In either case, data needs to be transferred to the roller mounting 350. For designs in which the control hardware 500 housed within the roller mounting 500, this data is image data that is accepted by the control hardware 500 for immediate or future use in switching the light sources 300. If, instead, the control hardware 500 is not housed within the roller mounting 350, but rather elsewhere, then switching signals that regulate the light sources 300 are provided to the roller mounting 350.

In either case, data or signal transfer to the roller mounting 350 can be achieved using wireless communications, such as infra-red (IR) signals. Narrow angle infra-red communications requires alignment of transmitting and receiving ports, but can support relatively high capacity communications are relatively low power.

Power can be supplied to the roller mounting via brushing contacts. Such an arrangement may be subject to wear, and a more convenient approach that can be adopted is to generate sufficient electrical power though an electromagnetic generator housed within the roller mounting. Effectively, light sources 300 are powered by the electromagnetic generator, which is powered in turn by the mechanical drive of the motor 400. As a steady rotational rate is the operational norm, a small electromagnetic generator can be appropriately selected to generate a predictable power output sufficient to drive the light sources 300.

Other designs may call for solar or perhaps even inductive powering of the light sources 300. An inductive power supply operates in a manner similar to a transformer, and has a stationary and a rotating coil. Inductive power supplies are commercially available either as “off-the-shelf” products or as custom-made assemblies. One supplier is Telemetrie Elektronik GmbH of Germany.

Control Hardware

Control hardware 500 controls the light sources 300 that compose an image displayed by the screen 100. Data concerning the image to display is provided to the control hardware 500 and, in combination with information from the roller mounting 350, signaling information is provided to the light sources to synchronize with their rotation relative to the optical pathways 200.

A frame is displayed by scanning a complete line at a time, in sequence, so that the entire screen is thus scanned to produce a complete image. Each particular light source displays one pixel at a time. Multiple light sources conveniently scan multiple respective pixels at the same time. These multiple light sources cycle through multiple respective pixels at a rate suitable to display a full frame.

The description that follows is simplified for convenience to a light source 300 limited to a column of only 8 single color LEDs. Each LED passes 180 optical waveguides in a single revolution. This creates a 1440 pixel display (8 LEDs×180 waveguides). Since one revolution of the light source corresponds to a complete frame, the speed of rotation is desirably greater than 25 revolutions per second to eliminate flicker. The described design is based upon 30 revolutions per second, corresponding to a 30 frames per second (fps) refresh rate.

The diameter of the rotating cylinder is 80 mm; the optical waveguides are positioned 2 degrees apart and are 0.75 mm wide. From this, the following indicative estimates can be derived, as indicated by Equations [1] and [2] below.

$$\begin{matrix}\begin{matrix}Distance traveled per revolution = 3.14 ( π ) \times 80 mm \\ = 251.2 mm\end{matrix} & [ 1 ] \\ \begin{matrix}Speed of travel at 30 fps = 251.2 mm \times 30 fps \\ = 7536 mm \text{/} second \\ = 133 µsec \text{/} mm\end{matrix} & [ 2 ]\end{matrix}$$

Therefore, each LED takes 133 μsec/mm×0.75 mm or approximately 100 μsec to pass a waveguide, referred to herein for convenience as a “light region”. Since the distance between the waveguides is 251.2 mm/180−0.75 mm=0.65 mm, each LED spends 133 μsec/mm×0.65mm, or approximately 85 μsec between waveguides, referred to herein for convenience as a “dark region”. Thus dark regions and light regions thus alternate at periods of 85 μs and 100 μs.

Vertical and Frame Synchronization

Each LED is switched on when required while passing through a “dark region” so that the maximum amount of light is transferred to appropriate waveguides during a light region. This requires a synchronization source that can be accomplished with an incremental optical encoder with a resolution of 180 pulses assembly or one can be constructed as part of the assembly. The encoder needs to be aligned so that a rising or falling pulse edge is produced at the beginning of the “dark region” to ensure maximum “set-up” time is available to a controlling circuitry to prepare for the next vertical scan. The width of the pulse is not critical as the controlling circuit only triggers on either a rising or a falling edge of the pulse.

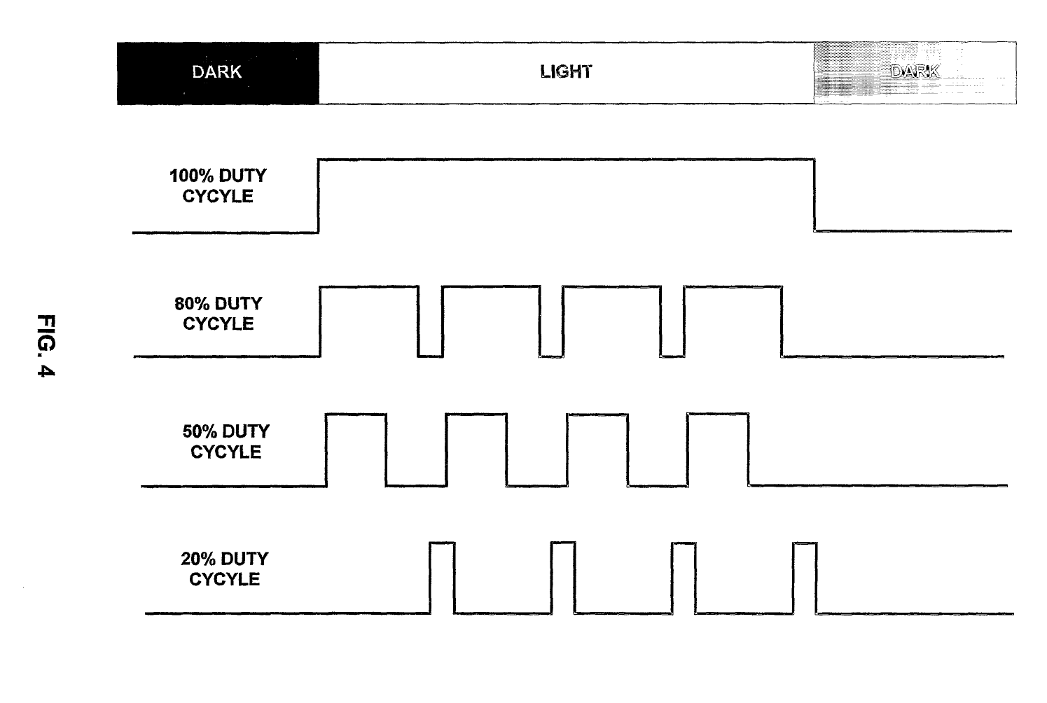

FIG. 3 is a timing diagram of required to display the letter “H” using a 6 pixel wide by 8 pixel high font. The “waveguide” row indicates light regions and dark regions by labels “L” and “D” respectively. A vertical synchronization pulse is triggered during each dark region, and a frame synchronization pulse is fired at the start of each frame. The signal for s each of LEDs 1 to 8 indicates the signal applied to, and consequent intensity of light from, these respective LEDs.

Adjacent light regions represent adjacent pixels. Accordingly, the horizontal axis indicates both a spatial and temporal dimension, due to rotational action. The entire timing diagram provides a “snapshot” indication of which pixels are activated at a given time, as well as the pattern of activation of individual LEDs as the LED rotates.

FIG. 3 indicates that the letter “H” is offset from the beginning of the frame and a pulse is required to indicate to a controlling circuitry the beginning of a frame.

Most incremental optical encoders provide a separate, single pulse per complete revolution (Z-phase or index). The encoder is aligned so that this pulse is produced between the first and last vertical scan lines. A controlling circuit uses this pulse to process the information required to display the next frame, or repeat the same frame in case of a static display.

Multiple Color Displays

Multiple color displays can be achieved by adding additional columns of different color LEDs, and exposing the same waveguides to light of different colors. For example, by using three columns of the “primary” colored red, green and blue LEDs, secondary colors such as cyan, magenta and yellow can be reproduced. Since the number of light sources is still only 8×3=24 LEDs, the amount of additional control hardware and complexity required to achieve multiple color displays is relatively slight.

Real Color Display

Full color displays producing realistic images can be achieved involving modulation of individual LEDs to control color intensity. Modulation provides an ability to mix color intensities to produce a larger number of colors. One way that this can be achieved is via pulse-width modulation (PWM).

A digital pulse train with a constant period and a fixed base frequency is used. To generate different levels of color, the duty cycle and thereby the pulse width of the digital signal is changed. If a higher level is needed, the pulse width is increased and vice versa.

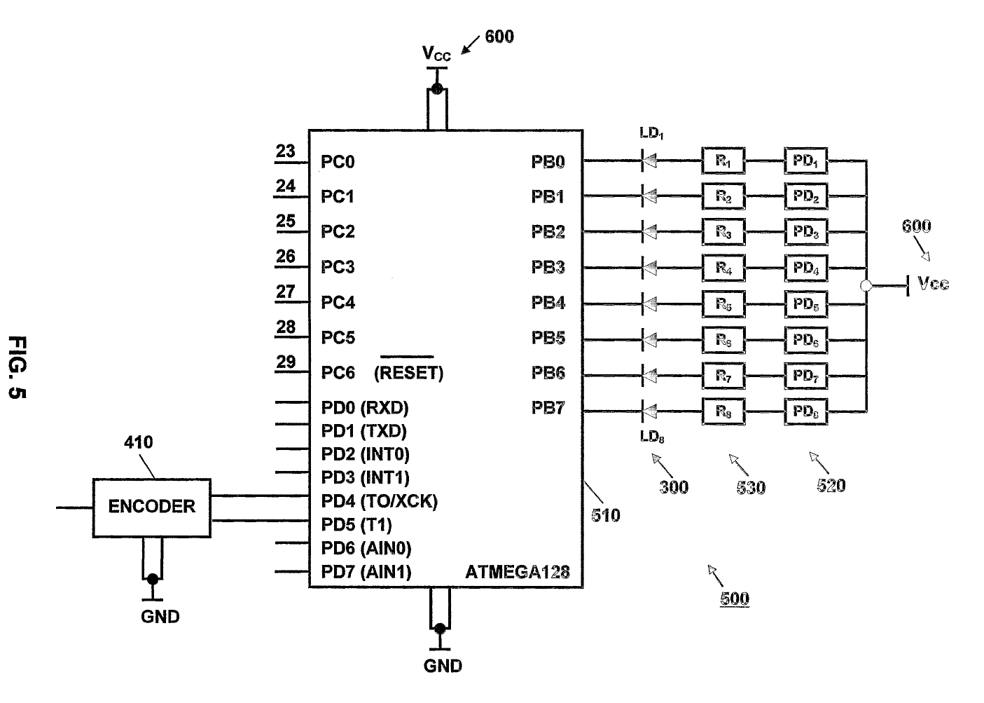

FIG. 4 is a timing diagram that depicts an example of a ten level color control scheme. To achieve a realistic spectrum of colors, a much higher level of control (implying a smaller time base) can be used.

The period chosen is significantly smaller (¼) of the “light region” period. A similar result could have been achieved with a period equal to that of the “light region” as the average value of the resultant analog signal is the same.

Hardware Controller Requirements

Simple applications of the described display (such as pre-programmed message displays) can be achieved with a single processor control board (PCB) containing a controller, a rotary encoder, power supply and supporting electronic circuitry mounted inside a spinning light source.

Atmel Corporation of San Jose, Calif. produces a range of controllers that are suitable for use in providing control hardware 500. An example is Atmel's AVR series of controllers. These have output buffers capable of sinking in excess of 20 mA of current and therefore capable of driving LEDs directly. These types of devices are appropriate for this application.

FIG. 5 schematically represents an electronic schematic layout of an ATMEGA128-6AC logic controller 510, which can form the core of the control hardware 500. This logic controller has five, eight-bit ports capable of driving the LEDs directly. This can equate to a single color display with 40×180=7200 pixels of resolutions, or a full color display with resolution of 13×180=2340 pixels.

To implement the described examples a small controller with 8 outputs and 2 inputs can be used. This can produce a text message display in excess of 22 characters, assuming a 6 pixels wide plus 8 pixels high font with 2 pixels of separation between characters.

Since variance in brightness between individual LEDs (LD₁ to LD₈ 300) of the same color and especially LEDs of different colors can be noticeable, potentiometers (PD₁ to PD₈ 520) can be added to current limiting resistors (R₁ to R₈ 530) to enable, if necessary, manual matching of brightness levels. Alternatively, this can be achieved using pulse width modulation, as described above.

Using an incremental, optical encoder for the purpose of vertical scan synchronization also simplifies the circuitry required to control the light source motor. Since the frame rate of 30 revolutions per second is considerably greater than the minimum required, any motor capable of sustaining approximately 1800 RPM can be driven directly without any need for speed control, as small fluctuations in speed will not substantially degrade the quality of the display.

The display can be blanked until the motor reaches desired speed, to prevent display flicker during motor start-up. This can easily be achieved with the index pulse of the encoder by measuring period or frequency of the index output.

The information required to be displayed can be transmitted via infrared remote control (which is a conventional way of providing data to displays of this “ticket-tape” type) as ASCII characters, which are internally converted by the logic controller to vertical scan lines look-up table, stored in a look-up table in the internal memory of the logic controller.

Since each scan line require a byte of storage, 6 columns by 22 characters=132 bytes is all that is required to store a complete frame. A multi color display will therefore require a maximum of 6 columns by 3 colors×22 characters=396 bytes of memory per frame.

Due to relatively small power requirements of this design, especially in the case of a single, rotating module device, to provide power via a rechargeable battery mounted inside the module. The battery can be charged during periods of inactivity (motor not running) via slip rings mounted on the main shaft. To prevent wear of the slip rings, a clutch-type mechanical assembly can disengage the slip rings when the motor starts and re-engage the slip rings as the motor stops.

Dual PCB Design

For more complex applications such as high resolution, full color displays, the hardware design can be separated in two PCBs. Most of the electronics, including a rotary encoder, is mounted on the main, stationary PCB. The main board receives a data stream that can be an image or a string of text and decodes this data down to a single vertical scan line. This is a standard feature of most types of visual display equipment.

A packet of data containing all the necessary information for a single vertical scan line can then be serially transmitted to the secondary PCB, located inside a rotating light source assembly, via an infrared receiver mounted on the rotating shaft of the assembly.

The whole packet needs to be transmitted during the “dark region” of rotation. This data is then converted by the secondary board in to vertical scan signals necessary to drive the LEDs during the “light region”.

Depending on the application, this data may contain either a direct status (on or off) of each LED for the approaching vertical scan line or in case of a real color display, it may contain pulse width modulation values representing duty cycle for each LED. For example, 1 byte per LED is required to achieve 256 levels (8 bit of resolution) of color control.

Some controllers, including ATMEGA128 510 described above, provide multiple, hardware-based pulse width modulation outputs (8 in case of ATMEGA128-6AC). A hardware-based PWM control is preferable to a software-based control as a hardware implementation operates independently of the logic controller's scan time. Programmable logic devices such as FPGAs (Field Programmable Gate Arrays) are better suited to large-scale displays consisting of many LEDs and requiring high resolution color control and therefore very high speed pulse width modulation.

Motor

A motor 400 can be installed with an independent detection device, such as an encoder 410, incorporated into the roller assembly to input signal to the electronic control system. Control hardware can be used to determine the precise positions of the light sources 300 positions against the waveguide channel positions.

An extremely accurate motor speed is not required, especially as the instantaneous speed variation can be managed so as not to affect the display quality if above mentioned detection device is installed as well as precise production as designed is achieved.

Apart from using motor and conventional method to provide rotation torque, liquid such as clear water can also be used to push special wheel device 380 as schematically illustrated in FIG. 7, which resemble reverse process of hydraulic electricity generator. In this design, small motor 400 will pump water into transportation channels; the micro-glass-capillaries 410 or 420. Water jet will effectively force the special wheel rotating clockwise if more water is pumped into 410 or anti-clockwise if more water pumped into 420. Wheel rotation speed will be controlled by water jet volume and direction by control valves. The outlets for water jet entering from micro-glass-capillaries 410 and micro-glass-capillaries 420 are micro-glass-capillaries 415 and micro-glass-capillaries 425 respectively. This design is suitable for revolving reflector option described in the below paragraph.

Design Alternative—Revolving Reflector

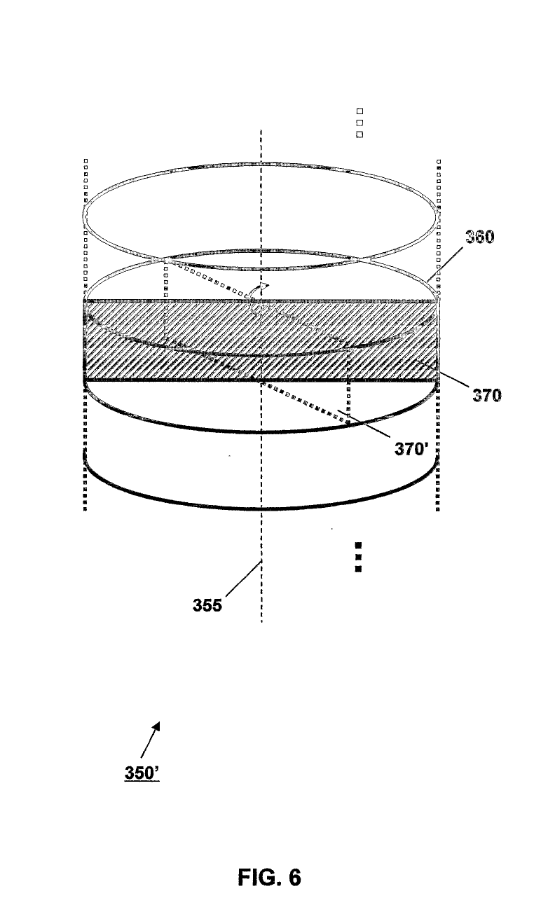

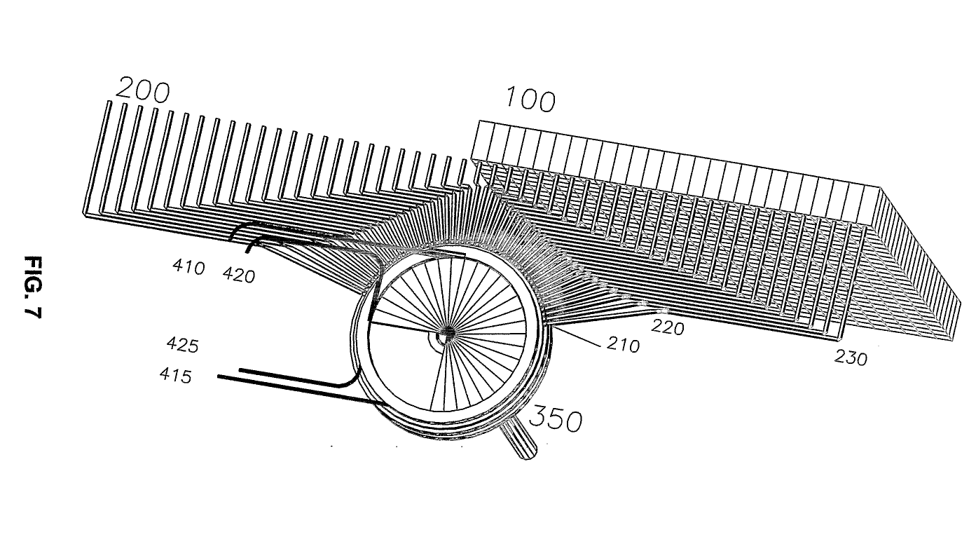

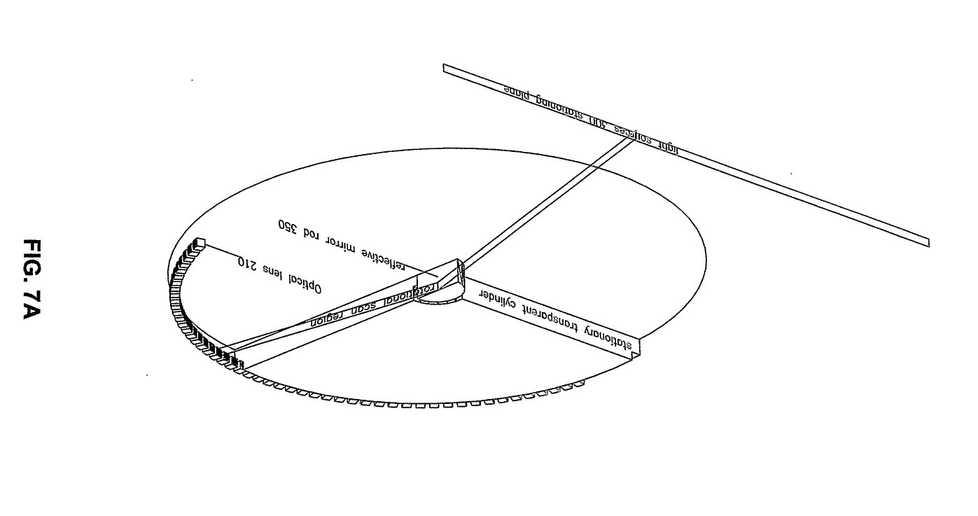

FIG. 6 schematically represents a portion of the revolving roller 350′, which consists of a cylindrical glass rod 360 having a smooth reflective planar surface. Passing through the centre axis 355 of the roller 350 is a double-sided reflective mirror surface 370. As the roller 350 rotates, the mirrored surface 370 rotates about its centre axis 355. The dashed section 370′ represents the surface 370 as it rotates with the roller 350. This reflective surface 370 redistributes light rays into apertures of different optical pathways 200. More than one group of light sources 300 can be accommodated for each “layer” of optical pathways 200.

Light beams produced by the light sources 300 are collimated, and couple with the optical pathways 200. Lasers sources are a convenient choice of light source, though other light sources 300 may be used. The resulting light beams strike the transparent roller 350′ perpendicularly or at a very small angle. Ideally any light ray beam-center will have one intersection point with the roller axis. The laser sources can be located in close proximity to the periphery of the roller 350′. They can also be arranged in one back plane where prisms will reflect laser beams into the required angles, which result in the same effect. For FIG. 7, the light sources 300 of same wavelength in the same “level” within the same column group will have its own focused intersection, which is also the focal point of each lens 210 located at the same level of circumference edge of distributional circle where reconstructed light beams will parallel to axis of the corresponding lens 210, of which they are coupled through.

One option for further minimizing phenomena arising from differences in reflection index between two transparent mediums such as the air space between rotating mirror rod and stationary transparent tube is to use a transparent liquid to fill up such a gaps. On the other hand, such difference is necessary for lens 210 and waveguide pathways 200 in design option shown in FIG. 7.

The advantage of this type of design is that the light sources 300 are motionless, so that design and manufacture is made easier. The reflective surface provides distributes or scans light amongst optical pathways 200. The light sources 300 waveguide pathway 200 can also be readily isolated from environmental moisture and humidity.

The control hardware 500 and light sources 300 can be affixed at the back of a waveguide screen 100. This architecture avoids problems associated with delivering the power supply and communications issues. The rotating component can be made relatively smaller compared to the rotating light sources design.

A further consideration is the relatively greater distance between the light sources 300 to the coupling end of an optical pathway 200. To optimize efficiency, any area that might have microscopic air gaps should be refilled with transparent sealant or clear liquid. For example, reflective mirror rod can be fully submerged in a liquid having a reflection index that matches that of the waveguide core and stationery circular rod. This liquid can also acts as a “lubricant”, and reduce mirror rod weight, which only requires very small DC motor 400 or other driving power to make it rotates.

Second option to lower cross talk in misalignment or light ray divergent angle is to have vertical and horizontal light absorption layers in each pixel floor. Please refer to the drawing for detail.

Optical lenses can be used to collimate the light sources 300, even if laser lights are the light sources 300. Such lenses can be used to precisely focus light from the light sources 300 to the apertures of the optical pathways 200.

The control hardware and its operation will be entirely similar to that used for the rotating light design.

Design Alternative—Multiple Modules

A single roller mounting 350 can be used, as described above. Multiple modules can be used as required to integrate into a larger and complete display panel 100, which in practice each modules of fully independent working unit will be functioning within its own task so that synchronized but associated picture frames are in fact display images or video seemingly being much larger area of one image.

Design Alternative—3D Visions

FIG. 7 in general has similar structure as FIG. 2 except following extra components or different layout.
1. The optic lens 210 located at the edge of the light scan distributional circumference in each level of stationary transparent cylinder.
2. Straight waveguide channels 200 instead of curve waveguide channels.
3. Maximum two internal reflection on planar reflective surfaces 210 and 220 within any waveguide channels whereas FIG. 2 doesn't offer such control.
4. Final optical system to redistribute light by scanning through a “native pixel” region with relatively unique and small profile light beams on the screen 100.

1. A visual display comprising:
a screen for either displaying image on surface area or emitting multiple layers of narrow divergent angles of chromatic light beams from each pixel by unidirectional and oscillating scan into front space of said screen with arbitrary unlimited and independent viewing positions;
optical pathways for supplying light to picture elements of the screen;
picture elements to distribute ambient 2D visual light information or vector 3D visual light information;
light sources able to be switched to transmit light to the optical pathways; and
control hardware for controlling switching of the light sources;
wherein light from the switchable light sources can be rotatably scanned to the optical pathways to display an image projecting from the screen.

2. The visual display of claim 1, further comprising a rotatable mounting substrate upon which the light sources are mounted to couple light to different optical pathways during rotation of the mounting substrate.

3. The visual display of claim 1, further comprising a rotatable transparent cylindrical substrate upon which its axis is coincide with single or multiple reflective plane(s) to reflect light from the stationary back light sources into different optical pathways during the rotation of the transparent substrate, which results in its circumference edge performs as indirect light sources as described in claims 2.

4. The visual display of claim 2, wherein the light sources are small emitting angle light sources such as LED.

5. The visual display of claim 3, wherein the light sources are laser or alike light sources.

6. The visual display of claim 1, wherein the light sources comprise but not limited to respective monochromatic primary coloured light sources.

7. The visual display of claim 1, wherein the optical pathways can be:
multiple layers of internally reflective medium transparent optical fibers whose coupling terminals have be made into cylindrical formation whilst exit terminals have be made into planar or curved surface as display area, or
multiple layers of highly transparent or hollow optical waveguide medium with each pathway has minimum one planar internal or external reflective surfaces. Convergent optical lens in each layer will be integrated into a transparent cylinder at the circumference edge of the said cylinder, of which its radius is equivalent to each len's focal length so that angular scan cause by rotational light sources as described in claimed 2 or mirror rotational effect as described in claimed 3 will be reconstructed into approximately parallel scan within its optical waveguide region described herein. Secondary lens structures can be deployed in each optical waveguide exit terminal into planar or curved formation as a screen.

8. The visual display of claim 1, wherein the picture elements of the screen are either rectangular in shape.

9. The visual display of claim 1, wherein the control hardware further controls the intensity and/or distribution direction of the light sources.

10. The visual display of claim 1, wherein the optical pathways are integral with the picture elements.

11. The visual display of claim 1, wherein the picture elements form a rectangular array.

12. A method of forming a visual display comprising the steps of:
storing data corresponding to an image to be displayed on a screen or simultaneous multiple-images designated to viewing positions at the space in front of a projection screen via optical pathways connected to picture elements of the screen;
determining a sequence in which light sources are to be switched by control hardware;
switching the light sources in accordance with the determined switching sequence; and
causing light from the switchable light sources to be rotatably scanned to the optical pathways to form the displayed image projecting from the screen.

13. The method of claim 12, wherein a rotatable mounting substrate upon which the light sources are mounted couples light to different optical pathways during rotation of the mounting substrate.

14. The method of claim 12, wherein a rotatable reflective element reflects light from the light sources to different optical pathways during rotation of the reflective element.

15. The visual display of claim 1, wherein optical pathways can either reversely transmitting electromagnetic wave signals originated from its own or nearby display control systems to intercept the echo of the signals.
